(19) United States
(12) Patent Application Publication
(10) Pub. No.: US 2011/0291628 A1
(43) Pub. Date: Dec. 1, 2011

(54) SWITCHING REGULATOR CIRCUIT AND METHOD FOR PROVIDING A REGULATED VOLTAGE

(76) Inventor: Frank BENY, Paderborn (DE)

(21) Appl. No.: 13/150,851

(22) Filed: Jun. 1, 2011

(30) Foreign Application Priority Data
Jun. 1, 2010 (DE) DE10 2010022380.8

(51) Int. Cl. G05F 1/10

(52) U.S. Cl. 323/282

(57) ABSTRACT

A switching regulator circuit and a method for providing a regulated output voltage for a load is provided that includes a comparator, whose comparator output signal is routed to a first oscillator control input, whereby a first comparator input voltage is present at a first input of the comparator and a second comparator input voltage is present at a second comparator input of the comparator, an oscillator with the first oscillator control input, at which the comparator output signal of the comparator is present, and whereby an oscillator output signal can be provided at an output of the oscillator, and by means of the signal the switching processes at a switching element can be controlled, by which a coil current can be influenced by a coil connected to the switching element, and a first compensator for influencing the second comparator input voltage as a function of the input voltage, whereby this first compensator is connected to the second comparator input of the comparator.

This nonprovisional application claims priority under 35 U.S.C. §119(a) to German Patent Application No. DE 10 2010 022 380.8, which was filed in Germany on Jun. 1, 2010, and which is herein incorporated by reference.

### BACKGROUND OF THE INVENTION

1. Field of the Invention

The invention relates to a switching regulator circuit and a method for providing an output voltage for a load.

2. Description of the Background Art

Switching regulator circuits are often used as a source of a substantially constant voltage or as a component of a DC-DC converter. The voltage value can be increased (boost converter) or reduced (buck converter) by means of a switching regulator circuit. To influence the output voltage and/or the load current of a switching regulator circuit, at least one switching element, especially a transistor, a power transistor (e.g., a power MOSFET), a GTO thyristor, or comparable components are often used, with which the amount of current supplied to the load is then varied by changing the turn-on/turn-off times (duty cycle).

Various embodiments of switching regulators are known from the state of the art. For example, FIG. 12A of U.S. Pat. No. 4,720,667 shows a so-called boost converter or step-up converter. In the same patent, a so-called buck converter or step-down converter is illustrated in FIG. 2A.

Furthermore, it is known from the conventional art to take circuitry-based precautions to protect the switching regulator circuit itself or the connected load from too high voltages or currents. It is known in particular to conduct the current, which flows through a switching element of the switching regulator, through a sense resistor and to compare the voltage drop across this sense resistor by means of a comparator with a reference voltage, to supply the result of this comparison to an oscillator, whereupon its output signal is adjusted, and as a result of this the sampling rate of the switching element can be influenced.

FIG. 1 shows a conventional switching regulator circuit of a boost converter. The conventional art will be explained first with use of this figure.

The switching regulator circuit S1 according to FIG. 1 is used to provide a regulated output voltage VUout and a limited current lout for a load Rout. The switching regulator circuit S1 has: an input voltage terminal Uin at which an input voltage can be applied; an output voltage terminal Uout which is provided to be connected to a load Rout, especially an ohmic resistor or another consumer; a comparator K, whose comparator output signal Sk is routed to a first oscillator control input OSin1, whereby a first comparator input voltage Uref can be applied at a first input Ref_In of comparator K and at a second comparator input Sense of comparator K a second comparator input voltage Up4 is present, which in FIG. 1 is equal to the voltage Up2 across sense resistor Rsense; and an oscillator OS, which has a first oscillator control input OSin1, whereby the comparator output signal Sk of comparator K is applied at the first oscillator control input OSin1, and whereby an oscillator output signal Sgate can be provided at an output OSout of oscillator OS, and by means of said signal the switching processes at a switching element T can be controlled, by which a coil current I_{L} can be influenced.

Oscillators, such as particularly the oscillator OS shown in FIG. 1, often have a second oscillator control input OSin2, which is used to bring about an adjustment of the output oscillator output signal Sgate (by the oscillator at its output OSout) when the output voltage (at the output voltage terminal Uout) of the switching regulator circuit S1 exceeds a limit, so that switching element T closes until the output voltage VUout has again dropped below a defined value.

The oscillator in FIG. 1 can be formed, for example, as a square-wave voltage generator, which emits a signal with a modulated pulse width. Such an oscillator is also called a pulse-width modulator, abbreviated as PWM. A field-effect transistor, which may be a metal-oxide-semiconductor field-effect transistor in particular, abbreviated as MOSFET, is shown by way of example as switching element T in FIG. 1.

The oscillator OS controls the gate GT of the switching element T with its oscillator output signal Sgate.

If the switching element T shifts to the conducting state, the transistor current It then drains off substantially across a low-resistance sense resistor Rsense to the ground potential terminal GND. At the same time, the magnetic field strength in the coil increases. If switching element T changes to the nonconducting state, then the magnetic field strength in coil L decreases and the induced voltage is supplied via flyback diode D to a capacitor C and/or a load R, if present.

Controlling the oscillator as a function of the output voltage VUout, which is present at a connection point P3 of the conventional switching regulator circuit S1, is prior in the art. For this purpose, a feedback signal dependent on the output voltage VUout is supplied to a second oscillator control input OSin2, which can be realized in the simplest case by a direct electrical connection from the output voltage terminal Uout to the second oscillator control input OSin2. If the output voltage VUout of switching regulator circuit S1 rises above a defined value, the oscillator output signal Sgate changes in such a way that switching element T blocks for a specific time. If the oscillator functions as a square-wave signal generator and outputs, for example, a pulse-width-modulated control voltage for switching element T, particularly a pulse-width-modulated gate voltage for a field-effect transistor, which is preferably a metal-oxide-semiconductor field-effect transistor, abbreviated as MOSFET, to switch switching element T, it is common, for example, to bring about a longer blocking of switching element T by shortening the turn-on time or the quotient of the turn-on time and period duration of the pulse-width-modulated control voltage, as a result of which the output voltage VUout of the switching regulator circuit decreases.

Furthermore, conventional switching regulator circuits often have a protection circuit, which under certain boundary conditions, particularly under the condition that the input voltage does not exceed a predefined maximum value, makes sure that the transistor current It through switching element T does not rise above the allowed extent, whereby this allowed extent of the current It, which flows through the switching element, is often determined by the component data.

This protection circuit utilizes the voltage Up2 which decreases across the sense resistor Rsense and in the embodiment according to FIG. 1 is supplied directly to the second comparator input Sense of comparator K. Comparator K compares the voltage Up2 with a reference voltage Uref which is present at the first comparator input Ref_In.

The sense resistor Rsense and the reference voltage Uref in conventional switching regulator circuits are typically dimensioned so that in the normal case, in which the voltage at the input voltage terminal Uin is within a narrow tolerance range around a defined allowable voltage value, the voltage Up2 across sense resistor Rsense is not above the reference voltage Uref, present at the first comparator input Ref_In.

Therefore, as long as the voltage Up2 across sense resistor Rsense is below the reference voltage Uref, comparator K does not generate a “fault signal,” which causes oscillator OS to bring about a blocking of switching element T. If, in contrast, the input voltage Uin rises above the established normal value, depending on the sampling rate of switching element T, the current It flowing through the switching element can also rise above the established normal value. Thereby, the voltage Up2 also increases, which is drawn in FIG. 1 and decreases across sense resistor Rsense, and is then compared with the first comparator input potential Uref. The comparison result can then lead to the situation that comparator K outputs a blocking signal to the first oscillator control input OSin1, whereupon the oscillator controls the gate GT of switching element T in such a way that switching element T blocks and a transistor current It no longer flows for a specific time.

The described process does protect switching regulator circuit S1 (particularly coil L and switching element T) as long as a sufficiently low-fluctuating input voltage is assured, but in this well-known approach according to the exemplary circuit in FIG. 1 when a relatively narrow input voltage interval, which depends on the characteristic data of the electronic components, is exceeded, damage to these components and thereby the entire circuit structure must be considered. The relatively narrow allowable input voltage interval is a major disadvantage in cases in which the input voltage Uin can be subject to variations, so that this narrow interval is quit.

The characteristic data of the electronic components of a switching regulator with the known design according to FIG. 1 must be dimensioned in such a way that both at a defined minimal input voltage VUin and at a defined maximum input voltage VUin, which can be present at input voltage terminal Uin, no damage to the circuit structure need be feared. Even with a specific selection of components, with the known circuit structure according to FIG. 1, it cannot be prevented that the allowable range of input voltages VUin is relatively narrow.

Thus, the fields of application for the known circuit structure according to FIG. 1 are limited to the cases in which it is assured that variations in the input voltage are within narrow limits.

The previously described switching regulator circuit according to FIG. 1 with the conventional protection circuit proves to be unsuitable for assuring sufficient protection in the case of variations in the input voltage, particularly for switching element T, and simultaneously a reliable supplying of the output voltage VUout at output voltage terminal Uout for a load. Conventional switching regulator circuits from the state of the art, particularly those of FIG. 1, frequently fail when there are input voltage variations at a ratio of 4 to 1 or higher, because then in the case of overloading of the switching regulator circuits the protective measures, such as the direct feedback of voltage Up2 to second comparator input Sense of comparator K as shown in particular in FIG. 1, offer no effective protection against a power overrun at higher input voltages within a broadened input voltage interval.

The protective measure in the circuit according to FIG. 1 is based substantially on current limiting measures for the switching element current It or the coil current I_{L}. This type of switching regulator circuits and similar conventional switching regulator circuits are suitable only for applications in which relatively low variations in the input voltage must be considered.

### SUMMARY OF THE INVENTION

It is therefore an object of the invention to provide an improved switching regulator circuit and an improved method for supplying an output voltage by means of a switching regulator circuit, by which the aforementioned disadvantages of the switching regulator circuits of conventional design are at least reduced, therefore particularly a switching regulator circuit and an associated method, whereby the interval of the allowable input voltages is broadened in comparison with conventional switching regulator circuits, particularly those with the design of the switching regulator circuit described in the introduction according to FIG. 1, and whereby a simple, space-saving, and cost-effective circuit structure is achieved, and whereby simultaneously a far-reaching protection of the components of the switching regulator circuit from overloading is assured.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 illustrates a conventional switching regulator;

FIG. 2 illustrates a switching regulator according to an embodiment;

FIG. 3 illustrates a switching regulator according to another embodiment; and

FIG. 4 shows a list of possible structural components with which the embodiments of the circuit of the invention can be realized.

### DETAILED DESCRIPTION

A switching regulator circuit according to an embodiment of the invention for providing a regulated output voltage VUout for a load Rout can include: an input voltage terminal Uin at which an input voltage can be applied, an output voltage terminal Uout which is provided and set up to be connected to the load Rout, a comparator K, whose comparator output signal Sk is routed to a first oscillator control input OSin1, whereby a first comparator input voltage Uref is present at a first input Ref_In of comparator K and a second comparator input voltage Up4 is present at a second comparator input Sense of comparator K, an oscillator OS with the first oscillator control input OSin1, at which the comparator output signal Sk of comparator K is present, and whereby an oscillator output signal Sgate can be provided at an output OSout of oscillator OS, and by means of said signal the switching processes at a switching element T can be controlled, by which a coil current I_{L} can be influenced by a coil L connected to switching element T, or a first compensator, having a pull-up resistor Rpull and a series resistor Rser, for influencing the second comparator input voltage Up4 as a function of the input voltage VUin, whereby this first compensator is connectable to the second comparator input Sense of comparator K.

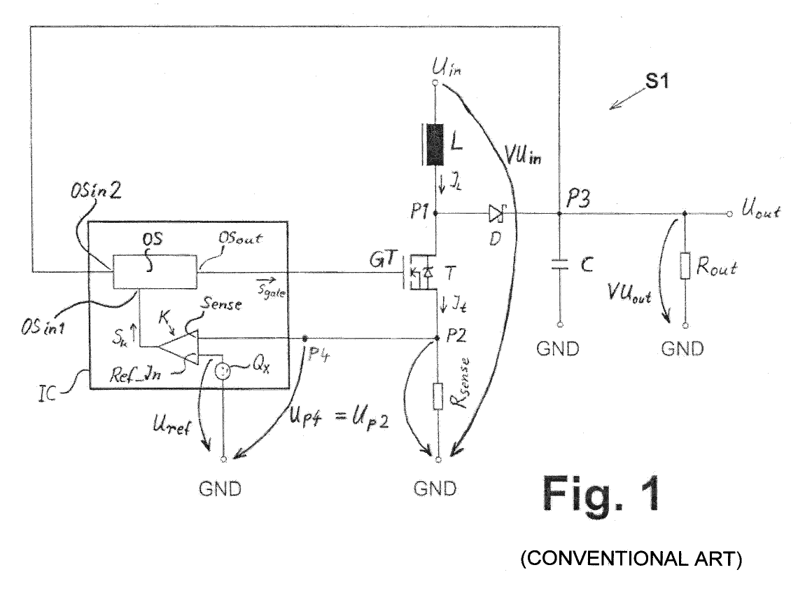

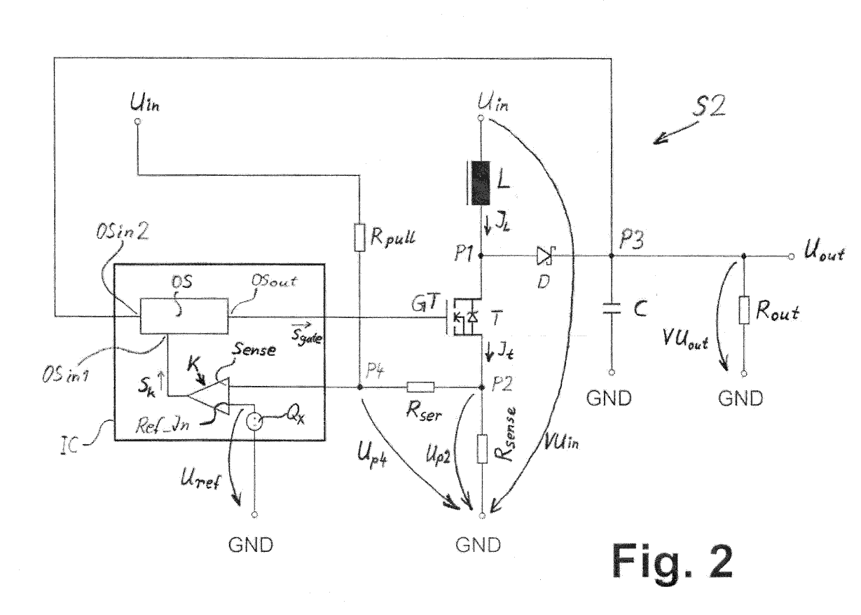

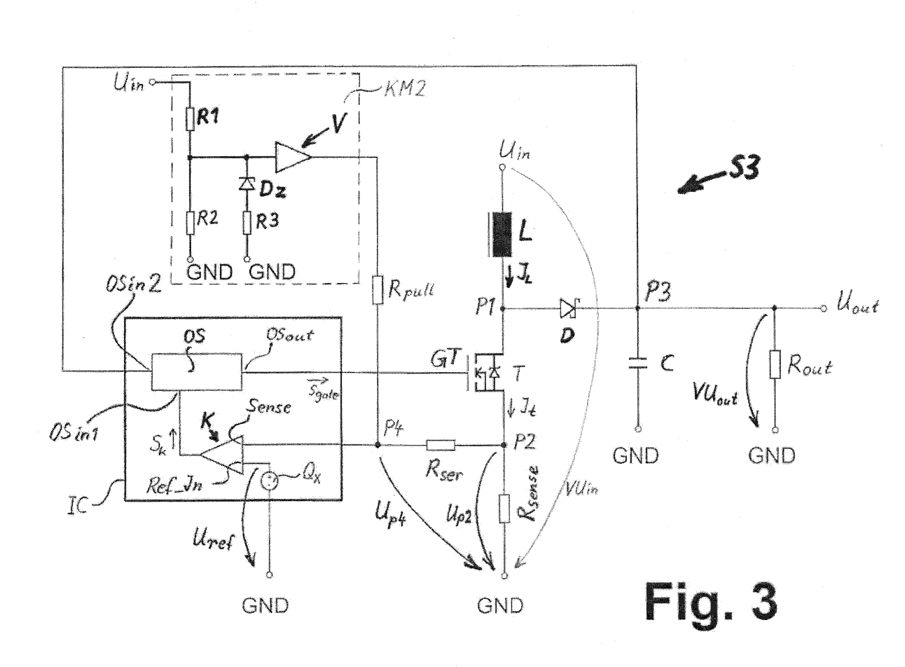

As becomes clear from the comparison of FIG. 1, which shows a conventional circuit structure, with FIGS. 2 and 3, which show especially preferred embodiments of the switching regulator circuit of the invention, the invention differentiates itself thereby from the state of the art in that novel compensation means are disclosed, and thereby the stated object of the invention can be achieved.

The switching regulator circuit of the invention can be realized with few, cost-effective electronic components and has a clearly broadened range of allowable input voltages in comparison with conventional switching regulator circuits from the prior art. “Allowable input voltages” are taken to mean substantially those input voltages in an electronic circuit structure at which a significantly increased deterioration rate in the electronic components of the circuit need not be expected within their generally typical lifetime, when the circuit structure is operated with these allowable input voltages.

An embodiment of the invention comprises a pull-up resistor Rpull and a series resistor Rser of the first compensation means, and preferably the first terminal of the series resistor (this is the terminal which is connected directly to the fourth connection point P4 in FIGS. 2 and 3) is also connected directly to the first terminal of the pull-up resistor Rpull, as also emerges from FIGS. 2 and 3. The second terminal of the pull-up resistor is connected either to the input voltage terminal (see FIG. 2) or to the second compensator KM2 (see FIG. 3). Therefore, in the case that the voltage at the second terminal of the pull-up resistor Rpull is raised, the second comparator input voltage Up4 at the fourth connection point P4 can also increase.

Without a first compensator according to an embodiment of the invention, it is not possible, for example, in a conventional switching regulator circuit according to FIG. 1 during use of customary and commercial electronic components, to cover an input voltage range of 4 V to 40 V with this conventional circuit. The sense resistor Rsense in FIG. 1 in this regard would have to be dimensioned either for input voltages close to 4 V or for input voltages close to 40 V. The switching regulator circuit of the invention in contrast can enable operation of the circuit, for example, within a range of input voltages of 4 V to 40 V, without different sense resistors Rsense for the top and bottom input voltage values of the mentioned range being necessary. The allowable input voltage range of the switching regulator circuit according to the invention is therefore clearly broadened compared with the allowable input voltage range of switching regulator circuits from the prior art, at least those according to FIG. 1. Intervention in the circuit structure of a regulator circuit within an integrated circuit, designated by IC in FIG. 1, is not a consideration as a solution for broadening the input voltage range simply because integrated circuits are usually encapsulated. The switching regulator circuit of the invention can be realized especially with the use of a commercial integrated circuit IC, because preferably the peripheral circuit components of the integrated circuit (provided an integrated circuit is used) and preferably not the integrated circuit itself overcome the mentioned problems of the prior art. Of course, the switching regulator circuit of the invention can be realized, for example, also with the use of discrete electronic components.

The load, symbolized in the figures by Rout, can be an ohmic resistor, for example. Alternatively, the load can be a complex consumer, consisting of a network, which has in particular a plurality of ohmic resistors, additional passive electronic components, and/or active components, such as particularly active semiconductor components.

The switching element T in the switching regulator circuit of the invention S2 or S3 can be a field-effect transistor, particularly a MOSFET.

Another embodiment of the switching regulator circuit according to the invention is notable in that a second terminal of coil L, the drain terminal of switching element T, and the anode of a flyback diode D are connected at a first connection point P1, whereby the cathode of the flyback diode D is connected to the output voltage terminal Uout, and whereby a first terminal of coil L is connected to the input voltage terminal Uin and/or to a second compensator KM2.

Also, a capacitor C can be provided for smoothing the output voltage Uout.

It is preferred further that in the switching regulator circuit the first compensator, having the resistors Rpull and Rser, has, on the one hand, a series resistor Rser, whose first terminal is connected to the second comparator input Sense and whose second terminal is connected to the source terminal of switching element T, and that the first compensator has, on the other hand, a pull-up resistor Rpull, whose first contact is connected to the second comparator input Sense of comparator K and whose second terminal is connected to the input voltage terminal Uin or to the second compensator KM2.

A further embodiment of the switching regulator circuit according to the invention is characterized in that the second comparator input voltage Up4, apart from being influenced by the first compensator Rpull, Rser, can be influenced by a voltage Up2 across a sense resistor Rsense connected in series to switching element T.

In a refinement of the switching regulator circuit of the invention, it is preferred that the first compensator for influencing the second comparator input voltage Up4 comprises the pull-up resistor Rpull, whose first terminal is connected to the first terminal of a series resistor Rser, whereby the second terminal of the pull-up-resistor Rpull is connected to the input voltage terminal Uin or the second compensator KM2, and whereby both a source terminal of switching element T and the second terminal of series resistor Rser and the first terminal of a sense resistor Rsense are connected at a second connection point P2, whereby the second terminal of the sense resistor Rsense is connected to a ground potential terminal GND.

This switching regulator circuit can be refined in such a way that the voltage Up2 across the sense resistor Rsense is the source voltage of the field-effect transistor, particularly of the MOSFET, which is embodied as switching element T, and that the second comparator input voltage Up4 can be influenced by the source voltage Up2 of the field-effect transistor, whereby a first terminal of a sense resistor Rsense and a second terminal of a series resistor Rser are joined at the source terminal P2 of the field-effect transistor or of the MOSFET, and whereby a connection between second connection point P2 and second comparator input Sense is created via the series resistor Rser.

In another embodiment of the switching regulator circuit according to the invention, at a fourth connection point P4 the first terminal of the pull-up resistor Rpull is connected to the second comparator input Sense of comparator K, and the second terminal of the pull-up resistor Rpull is connected to the input voltage terminal Uin or the second compensator KM2.

Other further refinements of the switching regulator circuit of the invention are designed in such a way that the first terminal of the pull-up resistor Rpull and a first terminal of the series resistor Rser are connected, and that a second terminal of said series resistor Rser is connected to the second connection point P2 and to the source terminal of switching element T and to the first terminal of sense resistor Rsense.

In additional embodiments of the switching regulator circuit according to the invention, a second oscillator control input OSin2 of oscillator OS, the cathode of the flyback diode D and the output voltage terminal Uout are connected at a third connection point P3, whereby oscillator OS has a component for influencing the oscillator output signal Sgate, which is supplied to the gate GT of the switch, depending on the output voltage VUout, whereby before the oscillator output signal Sgate is influenced, a comparison of the actual value of the output voltage VUout with the sought value of the output voltage VUout can be performed by the component of the oscillator OS.

In other further refinements of the switching regulator circuit, the first input Ref_In of comparator K for the purpose of providing a reference voltage Uref can be connected at this input to a reference voltage source Qx.

Other embodiments of the switching regulator circuit of the invention have comparator K and oscillator OS and/or reference voltage source Qx and/or the first and/or the second compensator within an electronic component, whereby this electronic component is preferably an integrated circuit IC.

Another embodiment of the switching regulator circuit according to the invention is notable in that the second compensator KM2 comprises a first resistor R1, a second resistor R2, a third resistor R3, and a Zener diode Dz, whereby the first terminal of the resistor R1 is connected to the input voltage terminal Uin and the second terminal of the first resistor R1 to the first terminal of the second resistor R2, and whereby both the second terminal of the second resistor R2 and the second terminal of the third resistor R3 are connected to the ground potential terminal GND, and whereby the first terminal of the third resistor R3 is connected to the anode of the Zener diode Dz, and whereby the cathode of the Zener diode Dz is connected to: the second terminal of the first resistor R1; and the first terminal of the second resistor R2; and a) the second terminal of the pull-up-resistor Rpull or b) the input of a buffer operational amplifier V, whereby in the case of b) the output of the buffer operational amplifier V is connected to the second terminal of the pull-up resistor Rpull.

The reference voltage source Qx of the switching regulator circuit can be provided and set up for the purpose of an adjustability of the first comparator input voltage Uref.

It is preferable, furthermore, during utilization of the switching regulator circuit of the invention, to use a method in which to provide the output voltage VUout for the load Rout, after the application of the input voltage VUin at input voltage terminal Uin of the switching regulator circuit, the first comparator input voltage Uref, which is present at the first input Ref_In of comparator K, is compared with a second comparator input voltage Up4, which is influenced by a first compensator Rpull, Rser at the second comparator input Sense, and the second comparator input voltage Up4, influenced by the first compensator Rpull, Rser, depends on the input voltage Uin and a current It through switching element T.

A refinement of this method is notable in that the comparator output signal Sk represents a result of the comparison of the first comparator input voltage Uref and the second comparator input voltage Up4, and whereby the comparator output signal Sk, output by comparator K, influences oscillator OS in that the oscillator output signal Sgate is changed by oscillator OS, whereby in the case of an overload of switching regulator circuit S2, S3 a time-limited blocking of switching element T is produced.

In an embodiment of the method, it can be provided that a signal is passed on from the second compensator KM2 to a pull-up resistor Rpull of the first compensator Rpull, Rser.

All in all, the circuit arrangement of the invention and the shown method for providing an output voltage is designed so that the aforementioned disadvantages of the switching regulator circuits of a conventional design are avoided or at least reduced, and particularly the interval of the allowable input voltage is broadened in comparison with conventional switching regulator circuits, which is attributable especially to an improved overload protection.

The circuit of the invention is moreover capable of countering a power overrange, therefore not only a current overrange, caused by high input voltages VUin within a broadened input voltage interval.

At the same time, the invention discloses a simple, space-saving, and cost-effective circuit structure.

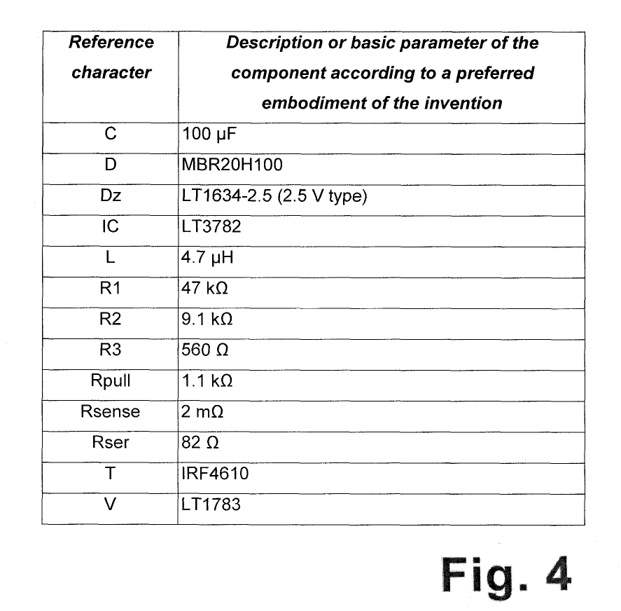

It is noted that the use of the structural components listed in FIG. 4 for realizing the circuit leads to another embodiment of the invention.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A switching regulator circuit configured to provide a regulated output voltage for a load, the switching regulator circuit comprising:
an input voltage terminal at which an input voltage is adapted to be applied;
an output voltage terminal configured to be connectable to the load;
a comparator having an output signal that is routed to a first oscillator control input, wherein a first comparator input voltage is adapted to be provided at a first input of the comparator and a second comparator input voltage is adapted to be provided at a second comparator input of comparator;
an oscillator having the first oscillator control input, at which the comparator output signal of the comparator is present, wherein an oscillator output signal is adapted to be provided at an output of the oscillator, and wherein, via the oscillator output signal, a switching process at a switching element is controllable, with which a coil current is configured to be influenced by a coil connected to the switching element; and
a first compensator configured to influence the second comparator input voltage as a function of the input voltage, the first compensator being connectable to the second comparator input of the comparator.

2. The switching regulator circuit according to claim 1, wherein the switching element is a field-effect transistor or a MOSFET.

3. The switching regulator circuit according to claim 2, wherein a second terminal of the coil, a drain terminal of the switching element, and an anode of a flyback diode are connected at a first connection point, wherein the cathode of the flyback diode is connected to the output voltage terminal, and wherein a first terminal of the coil is connected to the input voltage terminal and/or to a second compensator.

4. The switching regulator circuit according to claim 3, wherein the first compensator has a series resistor, whose first terminal is connected to the second comparator input and whose second terminal is connected to the source terminal of the switching element, and wherein the first compensator has a pull-up resistor, whose first contact is connected to the second comparator input of the comparator and whose second terminal is connected to the input voltage terminal or to the second compensator.

5. The switching regulator circuit according to claim 1, wherein the second comparator input voltage is configured to be influenced by a voltage across a sense resistor connected in series to the switching element.

6. The switching regulator circuit according to claim 4, wherein the first compensator for influencing the second comparator input voltage comprises the pull-up resistor, whose first terminal is connected to the first terminal of a series resistor, whereby the second terminal of the pull-up resistor is connected to the input voltage terminal or the second compensator, wherein both a source terminal of the switching element and the second terminal of the series resistor and the first terminal of a sense resistor are connected at a second connection point, and wherein the second terminal of the sense resistor is connected to a ground potential terminal.

7. The switching regulator circuit according to claim 6, wherein the voltage across the sense resistor is the source voltage of the field-effect transistor, which is embodied as the switching element, and the second comparator input voltage is influenced by the source voltage of the field-effect transistor, wherein a first terminal of the sense resistor and a second terminal of the series resistor are joined at the source terminal of the field-effect transistor, and wherein a connection between the second connection point and second comparator input is created via the series resistor.

8. The switching regulator circuit according to claim 4, wherein at a fourth connection point the first terminal of the pull-up resistor is connected to the second comparator input of the comparator, and the second terminal of the pull-up resistor is connected to the input voltage terminal or the second compensator.

9. The switching regulator circuit according to claim 5, wherein the first terminal of the pull-up resistor and a first terminal of the series resistor are connected, and a second terminal of the series resistor is connected to the second connection point and to the source terminal of the switching element and to the first terminal of the sense resistor.

10. The switching regulator circuit according to claim 3, wherein a second oscillator control input of the oscillator, the cathode of the flyback diode, and the output voltage terminal are connected at a third connection point, wherein the oscillator is configured to influence the oscillator output signal based on the output voltage, wherein, before the oscillator output signal is influenced, a comparison of the actual value of the output voltage with a sought value of the output voltage is performed.

11. The switching regulator circuit according to claim 1, wherein the first input of the comparator that provides a reference voltage is connected to a reference voltage source.

12. The switching regulator circuit according to claim 1, wherein the comparator and the oscillator and/or the reference voltage source and/or the first compensator are realized within an electronic component, and wherein this electronic component is an integrated circuit.

13. The switching regulator circuit according to claim 3, wherein the second compensator comprises a first resistor, a second resistor, a third resistor, and a Zener diode, wherein the first terminal of the first resistor is connected to the input voltage terminal and the second terminal of the first resistor to the first terminal of the second resistor, and wherein both the second terminal of the second resistor and the second terminal of the third resistor are connected to the ground potential terminal, and wherein the first terminal of the third resistor is connected to the anode of the Zener diode, and wherein the cathode of the Zener diode is connected to the second terminal of the first resistor and to the first terminal of the second resistor and to a) the second terminal of the pull-up resistor or b) an input of a buffer operational amplifier, whereby in case b) the output of the buffer operational amplifier is connected to the second terminal of the pull-up resistor.

14. The switching regulator circuit according to claim 11, wherein the reference voltage source is provided and set up for an adjustability of the first comparator input voltage.

15. A method for providing the output voltage for a load via a switching regulator circuit according to claim 1, the method comprising:
after application of the input voltage at the input voltage terminal of the switching regulator circuit, the first comparator input voltage, which is present at the first input of the comparator, is compared with a second comparator input voltage, which is influenced by a first compensator at the second comparator input; and
the second comparator input voltage, influenced by the first compensator, depends on the input voltage and a current through the switching element.

16. The method according to claim 15, wherein the comparator output signal represents a result of a comparison of the first comparator input voltage and the second comparator input voltage, and wherein the comparator output signal, output by the comparator, influences the oscillator in that the oscillator output signal is changed by the oscillator, wherein, in a case of an overload of the switching regulator circuit a time-limited blocking of the switching element is produced.

17. The method according to claim 15, wherein a signal is passed on from the second compensator to a pull-up resistor of the first compensator.
